(19) United States
(12) Patent Application Publication
(10) Pub. No.: US 2026/0007273 A1
(43) Pub. Date: Jan. 8, 2026

(54) LID FOR A MOBILE OVEN

(71) Applicant: mzmP GmbH, Karlsfeld (DE)

(72) Inventor: Thomas Ellerstorfer, Karlsfeld (DE)

(21) Appl. No.: 19/259,083

(22) Filed: Jul. 3, 2025

(30) Foreign Application Priority Data
Jul. 3, 2024 (DE) 102024118953.3

(51) Int. Cl. A47J 36/06; A47J 36/04

(52) U.S. Cl. CPC A47J 36/06; A47J 36/04

(57) ABSTRACT

A lid for a cooking device, particularly a mobile oven for open flames and stovetops, includes a viewing window, a frame-like structure, and an attachment device that detachably connects the viewing window to the frame-like structure. The attachment device is elastic and connects to the viewing window at a first attachment point and to the frame-like structure at a second attachment point. A first attachment plane of the first attachment point is positioned lower in a height direction of the lid than a second attachment plane of the second attachment point.

### CROSS-REFERENCE TO RELATED APPLICATION

The present application claims priority to German Patent Application No. DE102024118953, filed on Jul. 3, 2024, the entire contents of which are herein incorporated by reference in its entirety for all purposes.

### TECHNICAL FIELD

The present invention relates to a lid for a cooking device, particularly a mobile oven for open flames and stovetops, and a cooking device with such a lid.

### BACKGROUND OF THE INVENTION

Outdoor cooking is becoming increasingly popular. In this context, cooking devices have continuously evolved.

In the state of the art, various types of lids for cooking devices are known that have viewing windows to monitor the condition of the food without having to remove the lid. For example, the Korean utility model KR200452884Y1 describes a lid with an integrated viewing window that allows observing the cooking process without having to open the lid.

The lid according to KR200452884Y1 comprises a structure where the viewing window is inserted into an opening in the lid. The viewing window is secured by a combined structure of upper and lower retaining elements that fix the viewing window in the opening. This structure allows for easy insertion and removal of the viewing window, which facilitates cleaning and maintenance.

Although the invention according to KR200452884Y1 offers certain advantages, there are also several disadvantages and problems:

The use of multiple retaining elements and connection mechanisms leads to a complex structure that increases manufacturing costs and complicates assembly. The multitude of components can also lead to a higher weight of the lid, making handling impractical, especially for mobile applications.

The rigid fixation of the viewing window in the lid opening can lead to problems with temperature fluctuations. As the materials expand differently, stresses and cracks can occur in the viewing window or in the retaining structure. This can impair the tightness and mechanical stability of the lid.

The complex structure and the multitude of connection mechanisms increase maintenance efforts. Cleaning the individual components is time-consuming, and disassembly and reassembly can be time-intensive and prone to errors.

The use of mechanical connection mechanisms poses a risk of increased material wear. In particular, the moving parts and areas that are regularly disassembled and reassembled are susceptible to wear, which shortens the lifespan of the lid.

### SUMMARY OF THE INVENTION

Based on the known state of the art, it is an object of the present invention to provide an improved solution for a lid for a cooking device that enhances the user's ability to monitor the cooking process and is also heat-resistant, space-saving, and lightweight.

This object is achieved by a lid with the features of claim 1 and a cooking device with the features of claim 12. Advantageous developments result from the dependent claims, the present description, and the figures.

Accordingly, a lid is proposed which has a viewing window and a frame-like structure, wherein the viewing window is detachably connected to the frame-like structure via an attachment device. The attachment device is designed to be elastic, whereby the viewing window can be connected at a first attachment point and the attachment device can be connected to the frame-like structure at a second attachment point. A first attachment plane of the first attachment point is positioned lower in the height direction of the lid than a second attachment plane of the second attachment point.

The proposed lid has the advantage that it is designed to be lightweight and heat-resistant. The elastic attachment device allows for expansion of the viewing window and reduces the risk of stresses when the glass is exposed to high temperatures from a gas burner, especially when the flame of the gas burner is directed directly at the viewing window. In other words, the elastic attachment device ensures that the viewing window remains flexible during temperature fluctuations and minimizes stresses or deformations. The different arrangement of the attachment planes in the height direction of the lid contributes to the secure fixation of the viewing window while allowing for compensation of movements in the structure, which improves the durability and stability of the lid.

Furthermore, the recessing of the viewing window allows for space-saving placement of a lid handle or lid knob as well as easy storage of the lid in a mobile oven, whereby the container of a mobile oven can be inserted into the recess of the lid.

The lid consists of a frame-like structure and an integrated viewing window. The frame-like structure serves as a supporting element that ensures the stability of the entire lid. This structure forms the basic framework of the lid and provides the necessary strength and integrity. The frame-like structure consists of a circumferential frame, preferably made of heat-resistant metal.

Elastic refers to the property of a material to return to its original shape and size after deformation by an external force, once the force is removed. This ability of the material is characterized by a certain stretchability, resilience, and load-bearing capacity that allow it to withstand repeated deformations without permanent deformation or breakage.

The viewing window is a transparent or semi-transparent part of the lid that allows observing the cooking process without having to lift the lid. The viewing window is connected to the frame-like structure via an attachment device. This attachment device is designed to be elastic and ensures that the viewing window is both securely fixed and remains flexible during temperature fluctuations.

The lid ensures heat retention and distribution. The lid helps to keep the heat inside the cooking device, thereby shortening cooking times and increasing energy efficiency.

Through the viewing window, the user can monitor the cooking process at any time, which is particularly advantageous for delicate foods.

The proposed lid is designed so that the viewing window can be easily removed and reinserted, which facilitates cleaning and maintenance.

The attachment device consists of two attachment points: a first attachment point and a second attachment point. The first attachment point supports the viewing window in a first attachment plane, which is positioned lower in the height direction of the lid than the second attachment plane of the second attachment point. This arrangement ensures a stable and flexible fixation of the viewing window.

The attachment device is preferably connected to the viewing window and the frame-like structure only by form-fit and/or force-fit.

Lower, in the sense of this patent application, means that the viewing window is preferably positioned below a lid plane in the height direction, which represents the highest point of a lid in the height direction.

In one example, the viewing window can be recessed by the height of the lid handle.

According to a further preferred development, it can also be provided that the attachment device at the first attachment point is designed to grip the viewing window at an edge area of the viewing window.

This can achieve that the viewing window is suspended in a floating manner.

A floating suspension, in the sense of this application, refers to the suspension of the viewing window where it is fixed or held at two separate points, similar to the principle of a swing. This type of suspension allows the object to move or swing freely while being held stably in the air or, in this case, in the cooking volume.

The attachment device grips the viewing window in the edge area, whereby the viewing window is fixed with the attachment device at the first attachment point and at the same time allows for easy assembly and disassembly. In other words, the attachment device is shaped congruently to the contour of the viewing window or the edge section of the frame-like structure at the attachment points, whereby the attachment device is in surface contact with the viewing window or with the contact surfaces of the frame-like structure.

The term “grip” is to be understood in such a way that the viewing window is connected, preferably clamped, by the attachment device on the top and bottom of the viewing window.

This construction also offers the advantages that the viewing window is securely held by the design of the attachment device in the edge area. This prevents the viewing window from slipping or falling out, especially during use at high temperatures or during transport. Moreover, this construction facilitates the replacement of the viewing window.

Furthermore, according to an equally advantageous embodiment, it can be provided that the attachment device at the second attachment point is arranged on at least one first contact surface in an edge area of the frame-like structure, so that the attachment device at the second attachment point is slidingly supported in the direction of the second attachment plane.

The term “sliding support” is to be understood in such a way that the attachment device can expand within the second attachment plane. However, the attachment device is pre-tensioned in such a way that it is wedged with the frame-like structure of the lid when installed.

This construction offers the advantages that the sliding support of the attachment device at the second attachment point compensates for the thermal expansion of the individual components of the lid. This prevents stresses and cracks from occurring in the viewing window or the frame-like structure. This flexibility improves the longevity and reliability of the lid, especially with frequent use and direct exposure of the viewing window to the flame of a gas burner, which can reach temperatures between 300-600° C., for a mobile oven. Furthermore, this can increase the duration of cooking, as the viewing window is not damaged despite several hours of direct heat input.

According to a further particularly preferred embodiment, it can be provided that the attachment device at the second attachment point is arranged on at least one second contact surface in an edge area of the frame-like structure, so that the attachment device at the second attachment point is slidingly supported in the direction of the second attachment plane. The first contact surface in the edge area of the frame-like structure of the lid is positioned lower in the height direction than the second contact surface in the edge area of the frame-like structure.

This allows for a better hold of the attachment device. The advantageous effect of this design is based on the fact that the attachment of the attachment device at the second attachment point can be improved. In one example, the second contact surface and the first contact surface form a step-like structure. This causes the second contact surface to form a stop for the attachment device when it expands.

Furthermore, the attachment device is designed in such a way that it covers a gap between the attachment device and the edge area of the frame-like structure of the lid at the first contact surface.

Moreover, the arrangement of the attachment device on two contact surfaces improves the stability of the lid. The specific height arrangement of the contact surfaces prevents the attachment device from slipping and covers the first gap, thereby improving the insulation capability and visual integrity of the lid. This contributes to better heat distribution and energy efficiency of the cooking device.

Preferably, the attachment device is pre-tensioned into the frame-like structure in the inserted state in such a way that the viewing window is detachably clamped into the frame-like structure of the lid.

The advantage of this design is that the viewing window can be detachably integrated into the attachment device. This allows the viewing window to be removed from the attachment device or the lid if necessary, e.g. for cleaning the viewing window. This offers the advantages that the pre-tension of the attachment device securely and firmly clamps the viewing window into the frame-like structure. This prevents unwanted loosening or slipping of the viewing window. This construction also improves the tightness of the lid and ensures that no heat escapes, which increases the energy efficiency and cooking performance of the device. Furthermore, this has the advantage that no additional components such as adhesives are necessary, which is also advantageous for health reasons.

In an equally preferred embodiment of the invention, it can also be provided that the attachment device is made of a heat-resistant material, preferably silicone, and the viewing window is made of heat-resistant glass and the frame-like structure is made of metal.

In one example, the viewing window can be made of quartz glass or ceramic glass. These materials are capable of withstanding high temperatures without losing their mechanical properties.

In one example, the frame-like structure can be made of aluminum, stainless steel or copper. Preferably, the lid is made of aluminum.

In one example, the attachment device is preferably made of a high-temperature silicone that is approved for food contact according to EU and FDA regulations, preferably VMQ (Vinyl Methyl Silicone Rubber).

Preferably, the attachment device has an elastic modulus in the range of 0.5 to 2 MPa, preferably 1 MPa. Furthermore, in one example, the yield point can be 100 to 300%, while the elongation at break can be over 500%.

The tensile strength of the material can further be 85 kgf/cm².

The attachment device allows the use of different materials for the viewing window, the frame-like structure and the attachment device, each of which has different thermal expansion properties. The attachment device thus ensures that the viewing window, the frame-like structure and the attachment device can expand due to the heat input on the lid.

These materials are capable of withstanding high temperatures, allowing the cooking device to be operated safely and reliably, even under extreme conditions.

Particularly preferably, the viewing window is ring-shaped or circular disc-shaped or also rectangular and preferably arranged in relation to the center of the lid.

Ring-shaped in the sense of this patent application is to be understood in such a way that the area in the center is not made of glass, but represents part of the frame-like structure of the lid.

This embodiment has the advantage that the lid is lighter, as the glass area is smaller than the remaining area of the lid. Furthermore, the frame-like structure is placed over a gas burner arranged in the center and the viewing window is not exposed to the direct heat of the burner.

It has been shown that the food placed under the viewing window experiences less heat radiation than the food placed under the frame-like structure. Therefore, it has been demonstrated that the viewing window should only provide enough visibility of the food to monitor the cooking process.

Circular in the sense of this patent application is to be understood in such a way that the viewing window is to be provided as a circular glass plane, where the center of the lid is also the center of the glass plane.

This arrangement is particularly advantageous as it ensures the best view of the cooking process.

The circular arrangement of the viewing window places the viewing window directly above the burner opening, so that the heat input is highest at this point and thus the expansion of the viewing window is also highest. It was surprisingly found that the proposed attachment device ensures the required expansion of the viewing window.

According to a further preferred embodiment of the invention, it can be provided that the viewing window is designed to be flat or concave or convex.

The flat design represents a cost-effective production. A concave design of the viewing window improves the heat distribution inside the volume to be covered. A concave viewing window can distribute the heat rays more evenly, which leads to more uniform cooking of the food and thus improves the quality of the cooking process.

A convex design has the advantage that condensation water created by the cooking process is directed outwards in the radial direction of the viewing window and drips into the food.

Finally, the invention can also be advantageously designed in such a way that the attachment device has an inward-facing flank in the direction of the center of the lid, which is arranged at an angle of 5-30°, preferably 10°-20° in relation to the height direction.

The flank points outwards in the radial direction, whereby the first attachment point is arranged closer to the center in the radial direction in relation to the center of the lid than the second attachment point.

This can improve the insertion of the viewing window. Furthermore, more light enters the cooking volume.

According to a further aspect of the invention, a cooking device, particularly a mobile oven for open flames and stovetops, is proposed, which has an inventive lid and a container. The bottom of the container has a burner opening and at least one grill grate.

The proposed cooking device allows for heating and cooking food with top and bottom heat. The burner opening in the bottom of the container allows for the placement of an external heat source that provides the necessary heat.

Through the construction of the lid and the placement of the grill grates, an even heat distribution within the cooking space is achieved. The viewing window in the lid allows the user to observe the cooking process without having to lift the lid, which minimizes heat loss.

The cooking device is designed to be easily and compactly transported and used in various locations. This makes it particularly suitable for outdoor use, for example when camping or on picnics.

Preferably, the grill grate has a first group of slot-shaped recesses in the outer area and/or the grill grate has detachable holding devices that can be detachably connected to an inner wall of the container.

The grill grate is thereby centered over the slope of the container of the mobile oven. The detachable holding devices ensure that the grill grate is spaced apart from the inner wall of the container to protect the container from scratches.

Furthermore, the detachable holding devices have the advantage that when the grill grate is used as a trivet, they also serve as spacers between the grill grate and the container bottom. The detachable holding devices are made of a heat-resistant material and ensure that the heat of the container is not transferred to the grill grate.

The advantage resulting from this is particularly that a grill grate with slot-shaped recesses allows for better air circulation and even heat distribution. The detachable holding devices facilitate the cleaning and maintenance of the grill grate and the container. These features make the cooking device particularly user-friendly and versatile, suitable for both private and professional use.

### BRIEF DESCRIPTION OF THE FIGURES

Preferred further embodiments of the invention are explained in more detail by the following description of the figures. They show:

FIG. 1A-C schematic cross-sectional views of a lid according to various embodiments;

FIG. 2 a schematic cross-sectional view of a cooking device, particularly a mobile oven, according to one embodiment; and

FIG. 3 a schematic top view of a grill grate of a cooking device according to a further embodiment.

### DETAILED DESCRIPTION

In the following, preferred embodiments are described with reference to the figures. Identical, similar or equivalently acting elements in the different figures are provided with identical reference signs, and a repeated description of these elements is partially omitted to avoid redundancies.

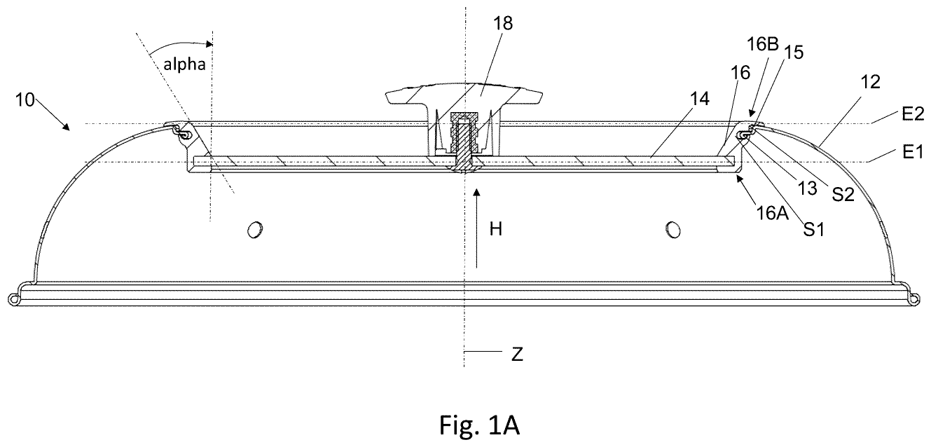

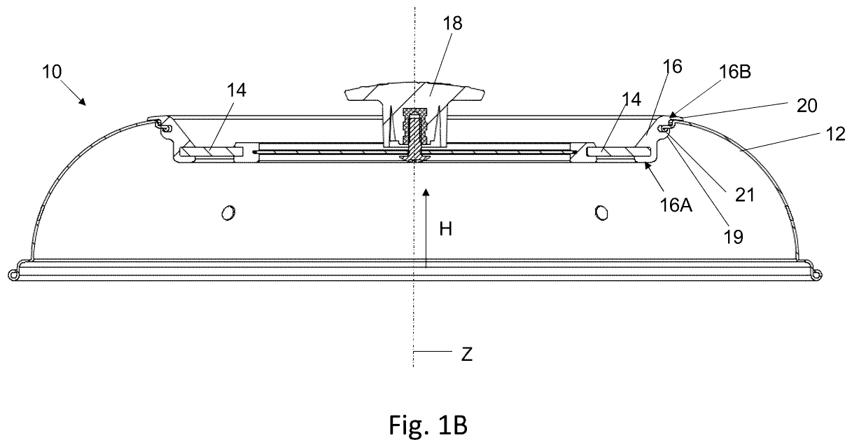

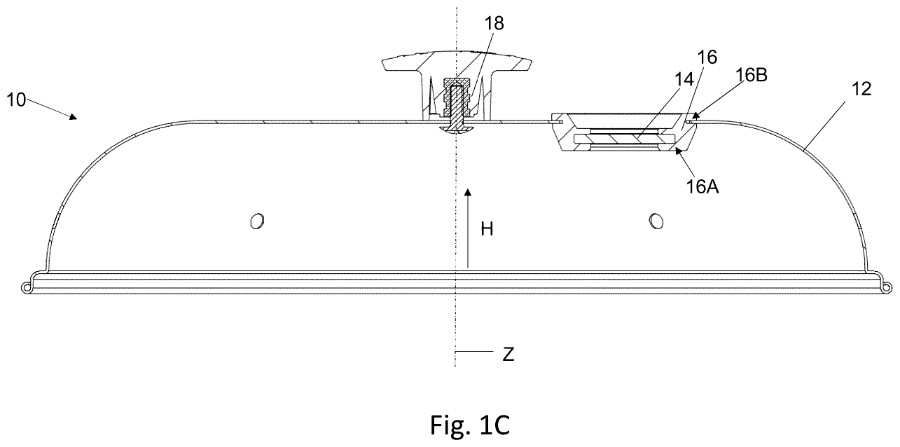

FIG. 1A shows a lid 10 for a cooking device, particularly a mobile oven for open flames and stovetops, according to one embodiment where the lid 10 has a viewing window 14 and a frame-like structure 12, wherein the viewing window 14 is detachably connected to the frame-like structure 12 via an attachment device 16. The attachment device 16 is designed to be elastic, which supports the viewing window 14 at a first attachment point 16A and connects it to the frame-like structure 12 at a second attachment point 16B. A first attachment plane E1 of the first attachment point 16A is positioned lower in the height direction of the lid than a second attachment plane E2 of the second attachment point 16B.

It can also be clearly seen from FIG. 1A that the attachment device 16 at the first attachment point 16A is designed to grip the viewing window 14 at an edge area of the viewing window 14.

As shown in FIG. 1A, the attachment device 16 at the second attachment point 16B is arranged on at least one first contact surface 13 in an edge area of the frame-like structure, so that the attachment device 16 at the second attachment point 16B is slidingly supported in the direction of the second attachment plane E2 or in a plane vertical to the height direction H.

The first contact surface 13 in the edge area of the frame-like structure is positioned lower in the height direction of the lid than the second contact surface 15 in the edge area of the frame-like structure.

In the example shown in FIG. 1A, the second contact surface 15 and the first contact surface 13 form a step-like structure. This causes the second contact surface to form a stop for the attachment device when it expands.

The step-like design at the edge area of the lid 10 provides increased rigidity. The lid can additionally have a flanged edge 21. The step-like design and the flanged edge 21 ensure improved structural integrity and strength of the lid.

The step-like design contributes to better tightness by ensuring that the attachment device 16 rests firmly and securely on the frame-like structure 12, thus preventing the penetration of liquids or other substances.

Furthermore, a first lip 19 of the attachment device 16 at the first attachment point 16A can hook behind the flanged edge 21, which ensures a secure and stable attachment.

Due to the step-like design, a second lip 20 of the attachment device can also be made thin. This results in the attachment device appearing essentially flush with the upper lid plane, providing a smooth and aesthetically pleasing surface.

These properties combine to create a design that is both functional and visually advantageous, fulfilling structural integrity, tightness, and aesthetic requirements equally.

The attachment device 16 can be designed in the area of the first contact surface 13, as shown in FIG. 1A, in such a way that it grips the first contact surface, i.e. rests on a top side and optionally contacts an underside, forming a gap S1 for expansion between the edge of the first contact surface 13 when inserted.

The attachment device 16 can be designed in the area of the second contact surface 15, as shown in FIG. 1A, in such a way that it rests on the second contact surface 15, forming a gap S2 for expansion between the edge of the second contact surface 15 when inserted.

The cutout in the frame-like structure 12 for inserting the viewing window is preferably circular or ring-shaped.

FIGS. 1A and 1B show that the viewing window 14 is arranged around the center of the lid in a ring-disc shape (FIG. 1B) or circular shape (FIG. 1A).

Finally, FIG. 1A also shows that the inward-facing flank of the attachment device in the direction of the center can be arranged at an angle of 5-30°, preferably 10°-20° in relation to the height direction H.

FIG. 1C shows another embodiment of a lid, where the lid 10 has a viewing window 14 and a frame-like structure 12, with the viewing window 14 eccentrically detachably connected to the frame-like structure 12 via an attachment device 16. The attachment device 16 is also designed to be elastic, which supports the viewing window 14 at a first attachment point 16A and connects it to the frame-like structure 12 at a second attachment point 16B. The first attachment plane E1 of the first attachment point 16A is also positioned lower in the height direction of the lid than the second attachment plane E2 of the second attachment point 16B.

This design has the advantage that the viewing window 14 can be made smaller and the frame-like structure 12 of the lid 10 does not need to be designed as rigidly. This allows the edge area of the frame-like structure 12 of the lid 10 to be executed without a step-like design, which reduces manufacturing effort.

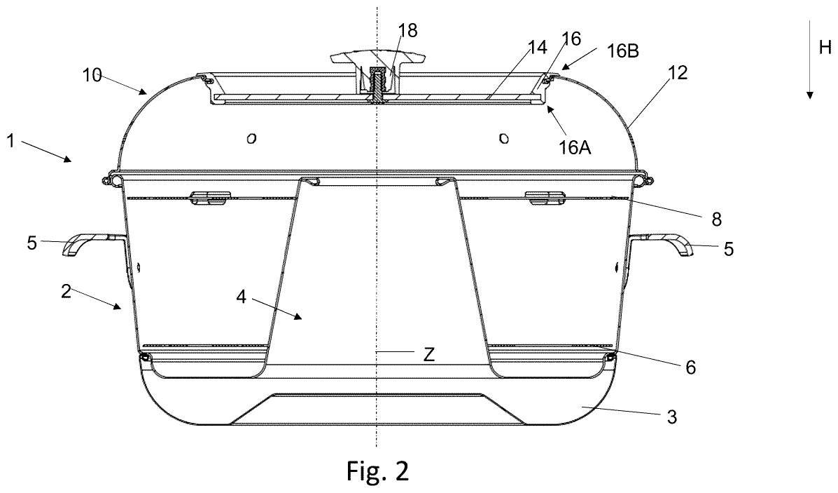

FIG. 2 shows a cooking device 1, particularly for a mobile oven for open flames and stovetops, comprising a lid 10 and a container 2, where a container bottom 3 has a burner opening 4. The cooking device also has at least one grill grate 6,8.

The container 2 forms the main body of the cooking device and serves as the cooking space for the food. The bottom of the container 3 is provided with a burner opening 4, which allows for the placement of a burner or heat source. Furthermore, container handles 5 are shown.

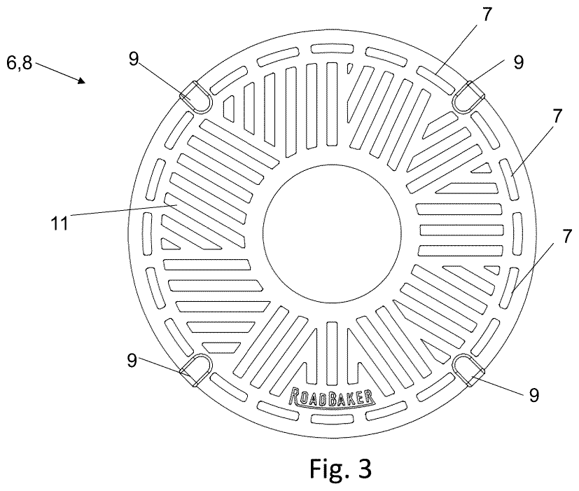

FIG. 3 shows a grill grate 6 of the cooking device, which has a first group of slot-shaped recesses 7 in the outer area. This allows the grill grate to be very user-friendly, for example, to be removed from the container of the cooking device using an external object such as a fork.

The cooking device contains at least one grill grate 6, 8, which serves to hold the food to be cooked. The grill grate is advantageously provided with a second group of slot-shaped recesses 11 to ensure optimal air circulation and heat distribution.

The burner opening is arranged around the center Z of the cooking device 1 and a lid handle 18 can be stored in the burner opening 4 when in the stowed position (not shown). The diameter of a flat part of the lid 10 is dimensioned in one example so that it can serve as a trivet for the container after the cooking process.

Furthermore, the grill grate 6,8 can be connected to an inner wall of the container via detachable holding devices, particularly detachable nubs, which allows for easy handling and cleaning.

The holding devices 9 are integrally designed and connected to the grill grate via a form-fitting connection, e.g. via a snap-in and click connection with the grill grate. The holding devices have a C- or L-shape, whereby the holding device is attached to the edge of the grill grate in the radial direction outwards.

The invention is not limited to the embodiments shown in the figures. The preceding description is therefore not to be considered as limiting, but as explanatory. The following patent claims are to be understood in such a way that a mentioned feature is present in at least one embodiment of the invention. This does not exclude the presence of further features. Insofar as the patent claims and the preceding description define ‘first’ and ‘second’ features, this designation serves to distinguish two similar features without establishing a ranking.

### LIST OF REFERENCE SIGNS

1 Cooking device
2 Container
3 Container bottom
4 Burner opening
5 Container handles
6,8 Grill grate
7 First group of recesses of the grill grate
9 Holding device
10 Lid
11 Second group of recesses of the grill grate
12 Frame-like structure
13 First contact surface
14 Viewing window
15 Second contact surface
16 Attachment device
16A First attachment point
16B Second attachment point
18 Lid handle
19 First lip
20 Second lip
21 Flanged edge
H Height direction
E1 First attachment plane
E2 Second attachment plane

That which is claimed is:

1. A lid for a cooking device, particularly a mobile oven for open flames and stovetops, comprising:
a viewing window;
a frame-like structure; and
an attachment device that detachably connects the viewing window to the frame-like structure;
wherein the attachment device is elastic and connects to the viewing window at a first attachment point and to the frame-like structure at a second attachment point; and
wherein a first attachment plane of the first attachment point is positioned lower in a height direction of the lid than a second attachment plane of the second attachment point.

2. The lid of claim 1, wherein the attachment device at the first attachment point grips the viewing window at an edge area of the viewing window.

3. The lid of claim 1, wherein the attachment device is arranged on at least a first contact surface in an edge area of the frame-like structure at the second attachment point, such that the attachment device is slidingly supported at the second attachment point in a direction of the second attachment plane.

4. The lid of claim 3, wherein:
the attachment device is arranged on at least a second contact surface in an edge area of the frame-like structure at the second attachment point, such that the attachment device is slidingly supported at the second attachment point in the direction of the second attachment plane; and
the first contact surface in the edge area of the frame-like structure is positioned lower in the height direction of the lid than the second contact surface in the edge area of the frame-like structure.

5. The lid of claim 1, wherein the attachment device is pre-tensioned into the frame-like structure in an inserted state such that the viewing window is detachably clamped into the frame-like structure of the lid.

6. The lid of claim 1, wherein the attachment device is made of a heat-resistant material, the viewing window is made of heat-resistant glass, and the frame-like structure is made of metal.

7. The lid of claim 6, wherein the heat-resistant material is silicone.

8. The lid of claim 1, wherein the viewing window is arranged around a center of the lid, and wherein the viewing window is ring-shaped, circular, or rectangular.

9. The lid of claim 1, wherein the viewing window is flat, convex, or concave.

10. The lid of claim 1, wherein the attachment device has an inward-facing flank in a direction of a center of the lid, the inward-facing flank being arranged at an angle of 5-30° in relation to the height direction.

11. The lid of claim 10, wherein the angle is 10-20° in relation to the height direction.

12. A cooking device, particularly a mobile oven for open flames and stovetops, comprising:
a lid according to claim 1;
a container having a container bottom with a burner opening; and
at least one grill grate.

13. The cooking device of claim 12, wherein the grill grate has a first group of slot-shaped recesses in an outer area.

14. The cooking device of claim 12, wherein the grill grate is detachably connected to an inner wall of the container via detachable holding devices.
